(19) United States
(12) Patent Application Publication
(10) Pub. No.: US 2018/0182084 A1
(43) Pub. Date: Jun. 28, 2018

(54) GAS LEAKAGE DETECTION METHOD

(71) Applicant: INDUSTRIAL TECHNOLOGY RESEARCH INSTITUTE, Chutung (TW)

(72) Inventors: Yi-Hsiu LEE, Kaohsiung City (TW); Hao-Ting CHAO, Taichung City (TW); Hung-Chun LIN, Kaohsiung City (TW)

(21) Appl. No.: 15/392,817

(22) Filed: Dec. 28, 2016

(30) Foreign Application Priority Data
Dec. 23, 2016 (TW) 105143006

(51) Int. Cl. G06T 5/50; G06K 9/62; G06T 5/20; G06T 5/00

(52) U.S. Cl. CPC G06T 5/50; G06K 9/6215; G06T 5/20; G06T 5/003; G06T 2207/20201; G06T 2207/10016; G06T 2207/10048; G06T 2207/20221; G06T 5/002

(57) ABSTRACT

A gas leakage detection method is provided. The method includes the followings steps. Receive an infrared video. Capture a first image and a second image from the infrared video, wherein the first image and the second image are consecutive image frames in order. Calculate a difference between the first image and the second image to generate a first difference image. Filter the first difference image with a filtering criterion to generate a first filtered image. Transform the first filtered image with a transfer function to generate a first detail image, wherein the absolute value of pixel value in the first detail image is greater than or equal to the absolute value of corresponding pixel value in the first filtered image. Superimpose the first detail image and the first image to generate a gas leakage enhanced image.

This application claims the benefit of Taiwan application Serial No. 105143006, filed Dec. 23, 2016, the subject matters of which are incorporated herein by references.

### TECHNICAL FIELD

The disclosure relates to an image processing method, and more particularly to an image processing method for gas leakage detection.

### BACKGROUND

Volatile organic compounds (VOC) in air, such as propylene, ethanol, diethyl ether, and dichloromethane, may cause environmental and human hazards. Moreover, some gas is likely to induce combustion or explosion reaction when being near a fire source. Currently large petrochemical plants detect gas leakage mainly by detecting each valve with quantitative detectors. This approach consumes much detection time. Thus there is a need for an efficient approach for detecting gas leakage.

### SUMMARY

The disclosure relates to a gas leakage detection method.

According to one embodiment, a gas leakage detection method is provided. The method includes the following steps. Receive an infrared video. Capture a first image and a second image from the infrared video, wherein the first image and the second image are consecutive image frames in order. Calculate a difference between the first image and the second image to generate a first difference image. Filter the first difference image with a filtering criterion to generate a first filtered image. Transform the first filtered image with a transfer function to generate a first detail image, wherein an absolute value of each pixel value in the first detail image is greater than or equal to an absolute value of each corresponding pixel value in the first filtered image. Superimpose the first detail image and the first image to generate a gas leakage enhanced image.

### BRIEF DESCRIPTION OF THE DRAWINGS

FIG. 1 shows a diagram of a gas leakage detection system according to an embodiment of this disclosure.

FIG. 2 shows a flowchart for a gas leakage detection method performed by the image processing device shown in FIG. 1.

FIG. 3 shows a flowchart for a gas leakage detection method according to an embodiment of this disclosure.

FIG. 4A and FIG. 4B show diagrams illustrating nonlinear transfer function examples according to an embodiment of this disclosure.

FIG. 5 shows a diagram illustrating an image processing device according to an embodiment of this disclosure.

FIG. 6 shows a diagram illustrating an image processing device according to an embodiment of this disclosure.

FIG. 7 shows a diagram illustrating an image processing device according to an embodiment of this disclosure.

FIG. 8 shows a flowchart for the image stabilization compensation step according to an embodiment of this disclosure.

FIG. 9 shows a diagram illustrating block motion vectors according to an embodiment of this disclosure.

FIG. 10 shows a diagram illustrating the global motion vector according to an embodiment of this disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

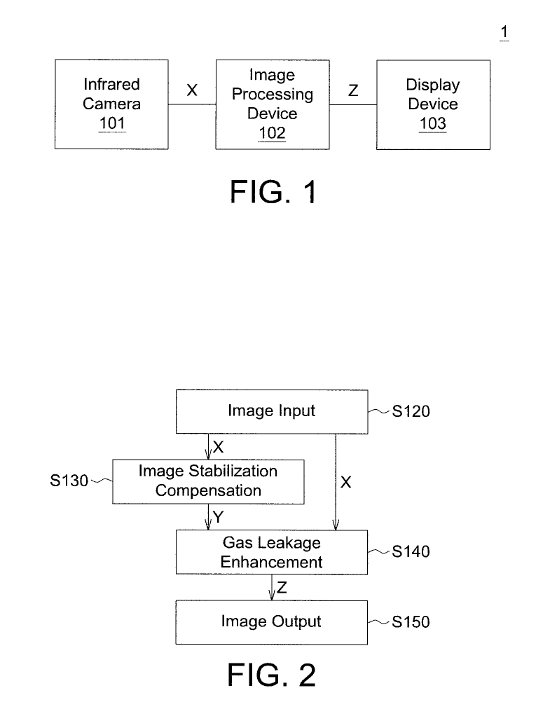

In the following embodiments, gas leakage may be detected by an infrared thermal image. FIG. 1 shows a diagram of a gas leakage detection system according to an embodiment of this disclosure. The gas leakage detection system 1 includes an infrared (IR) camera 101, an image processing device 102, and a display device 103. The infrared camera 101 may use infrared light with wavelength 3 μm-4 μm to record a video for an environment that needs gas leakage detection to obtain an infrared video X. The infrared camera 101 may be a handheld device, such that the operator may conveniently carry the infrared camera 101 to record video for the monitored environment. The infrared video X obtained by the infrared camera 101 may be transmitted via line or network to the image processing device 102. The image processing device 102 may be an external computer or a digital signal processor inside the infrared camera 101. The image processing device 102 may perform the gas leakage detection method described below to process the infrared video X to generate a gas leakage enhanced image Z for the display device 103. The user may watch the processed image on the display device 103 to find out the gas leakage quickly and accurately. The display device 103 is for example a liquid crystal display (LCD) or an organic light emitting diode (OLED) panel. The display device 103 may be external to the infrared camera 101 or may be integrated with the infrared camera 101.

FIG. 2 shows a flowchart for a gas leakage detection method performed by the image processing device shown in FIG. 1. The method includes the step S120 image input, such as receiving the infrared video X from the infrared camera 101. In one embodiment, the infrared camera 101 may be a fixed device, and the step S140 gas leakage enhancement may be executed directly after the step S120. The step S140 may enhance the location where the gas leakage happens in the image, such that the user may clearly find out the gas leakage more quickly. In another embodiment, the step S130 image stabilization compensation may be optionally performed after the step S120 to reduce the image shaking resulting from the infrared camera 101 being held by the operator. The step S130 performs stabilization compensation to generate a stabilized infrared video Y, such that the user can watch the video more easily and the accuracy of the step S140 can also be improved. The step S140 performs gas leakage enhancement on the infrared video X or the stabilized infrared video Y to generate the gas leakage enhanced image Z. The step S150 transmits the gas leakage enhanced image Z to the display device 103. The method shown in FIG. 2 may be implemented by computer software, such as a program stored in the computer memory to be loaded and executed by a processor. Alternatively, the method shown in FIG. 2 may also be implemented by hardware circuit, such as a digital signal processor. Detailed description about the step S130 and the step S140 is given below.

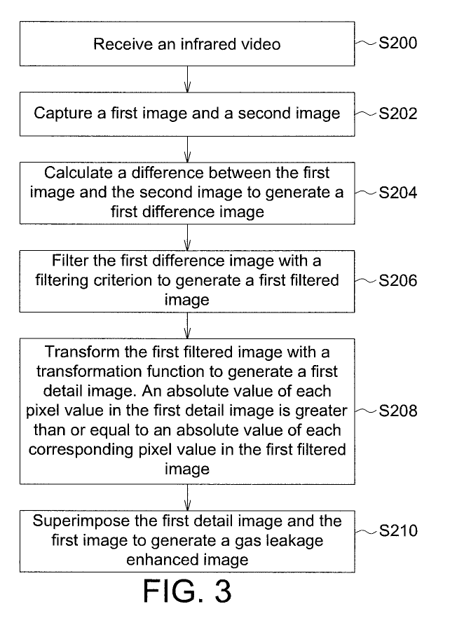

FIG. 3 shows a flowchart for a gas leakage detection method according to an embodiment of this disclosure. The method includes the following steps. Step S200: Receive an infrared video X. Step S202: Capture a first image Img1 and a second image Img2 from the infrared video X, wherein the first image Img1 and the second image Img2 are consecutive image frames in order. Step S204: Calculate a difference between the first image Img1 and the second image Img2 to generate a first difference image D1. Step S206: Filter the first difference image D1 with a filtering criterion to generate a first filtered image F1. Step S208: Transform the first filtered image F1 with a transfer function to generate a first detail image M1, wherein an absolute value of each pixel value in the first detail image M1 is greater than or equal to an absolute value of each corresponding pixel value in the first filtered image F1. Step S210: Superimpose the first detail image M1 and the first image Img1 to generate a gas leakage enhanced image Z. Detailed description of each step is given below.

Referring to the flowchart in FIG. 2, an image stabilization compensation step may be optionally performed between the step S200 and the step S202 as shown in FIG. 3. In other words, the step S202 may capture the first image Img1 and the second image Img2 directly from the infrared video X, or capture the first image Img1 and the second image Img2 from the stabilized infrared video Y. For example, the first image Img1 is a current time image frame, and the second image Img2 is a previous time image frame. Taking the frame rate as 30 fps for example, the time interval between the first image Img1 and the second image Img2 is

$$\frac{1}{30}$$

second.

Because the gas leakage may cause image difference between a previous time image and a next time image in the infrared thermal video, the step S204 identifies the difference between the first image Img1 and the second image Img2. The first difference image D1 may be obtained by subtracting the pixel value of the second image Img2 from the pixel value of the first image Img1. The pixel value of the first difference image D1 may be positive (the image becomes brighter from the second image Img2 to the first image Img1) or negative (the image becomes darker from the second image Img2 to the first image Img1).

Next, in the step S206, the difference obtained in the step S204 is filtered appropriately to exclude the difference value that is not caused by the gas leakage. In one embodiment, the step S206 includes filtering out a pixel value in the first difference image D1 having an absolute value greater than a difference upper bound D_{UB} or lower than a difference lower bound D_{LB}. For example, the difference upper bound D_{UB} is 40, and the difference lower bound D_{LB} is 5. Each pixel in the first difference image D1 is filtered. If the pixel value is greater than 40 or less than −40, such a great difference may be caused by reasons other than gas leakage, and thus the pixel value may be filtered out, such as being set as 0 in the first filtered image F1. Similarly, if the pixel value ranges from −5 to 5, the pixel value may also be set as 0 in the first filtered image F1. If the pixel value ranges from 5 to 40 or ranges from −5 to −40, this pixel value may be kept in the first filtered image F1. Values for the difference upper bound D_{UB} and the difference lower bound D_{LB} given here are merely exemplary rather than limiting the invention.

In order to enhance the difference part in the image, a transfer function TF is used in the step S206 to magnify the difference. Following the example given above, the pixel value in the first filtered image may be 0, ranging from 5 to 40, or ranging from −5 to −40. The transfer function TF may provide different magnification ratios for different pixel values. For example, a pixel value 5 may be magnified to 6, a pixel value 10 may be magnified to 15, a pixel value 40 may be magnified to 80, and so on. The values shown here are also merely exemplary.

There may be several embodiments for the transfer function TF. In one embodiment, the transfer function TF may be a constant function, which provides the same magnification ratio for different pixel values. In one embodiment, the transfer function TF may be a linear function, which provides smaller magnification ratio for smaller pixel values, and provides larger magnification ratio for larger pixel values. The magnification ratio grows linearly with the pixel value. In one embodiment, the transfer function TF may be a nonlinear function, where the magnification ratio grows nonlinearly with the pixel value. The magnification ratio may saturate after reaching a certain value. A nonlinear transfer function may result in a better image enhancement result. In one embodiment, the transfer function is generated according to a sigmoid function. For example, the transfer function may be represented as

$${TF}_{s} ( x ) = \frac{1}{1 + {e}^{- x}} ,$$

where x is the absolute value of the pixel value. After being magnified by transfer functions in the above embodiments, the absolute value of each pixel value in the first detail image M1 is greater than or equal to the absolute value of each corresponding pixel value in the first filtered image F1.

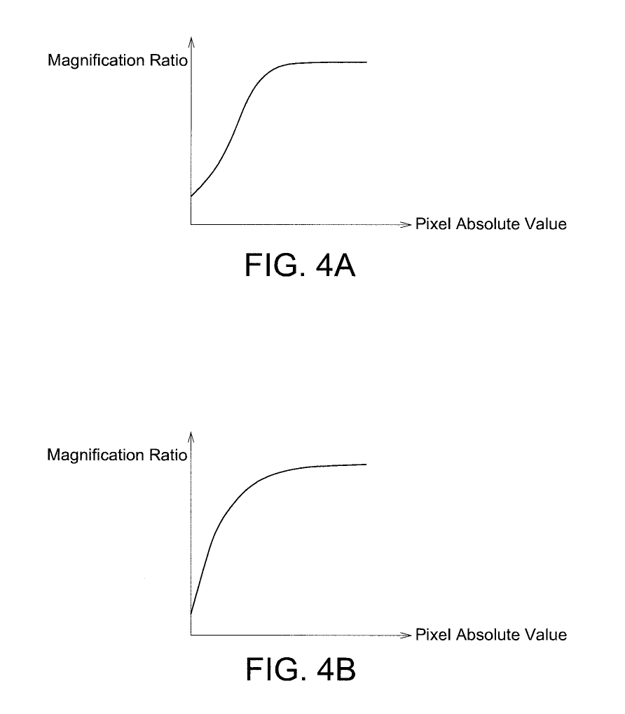

FIG. 4A and FIG. 4B show diagrams illustrating nonlinear transfer function examples according to an embodiment of this disclosure. The function shown in FIG. 4A is generated by shifting the sigmoid function in the horizontal direction and changing magnitude in the vertical direction. The horizontal axis represents the absolute value of the pixel value, and the vertical axis represents the magnification ratio. For example, a pixel value +6 and a pixel value −6 in the first filtered image are applied the same magnification ratio (enlarged to +9 and −9 respectively). The magnification ratio saturates after the pixel absolute value reaches a certain value. This is due to the fact that applying an appropriate magnification ratio is enough for the image region that already has sufficiently large difference value. FIG. 4B shows another example of a nonlinear transfer function TF.

The first detail image M1 shows a filtered and magnified result of the difference between the current time first image Img1 and the previous time second image Img2. Therefore, the step 210 may superimpose the first detail image M1 and the original first image Img1, thereby adding enhanced detail difference on the original image, to generate the gas leakage enhanced image Z. After the method as shown in FIG. 3 processes the image difference, the user can clearly and quickly identify the location where gas leakage happens from the gas leakage enhanced image Z.

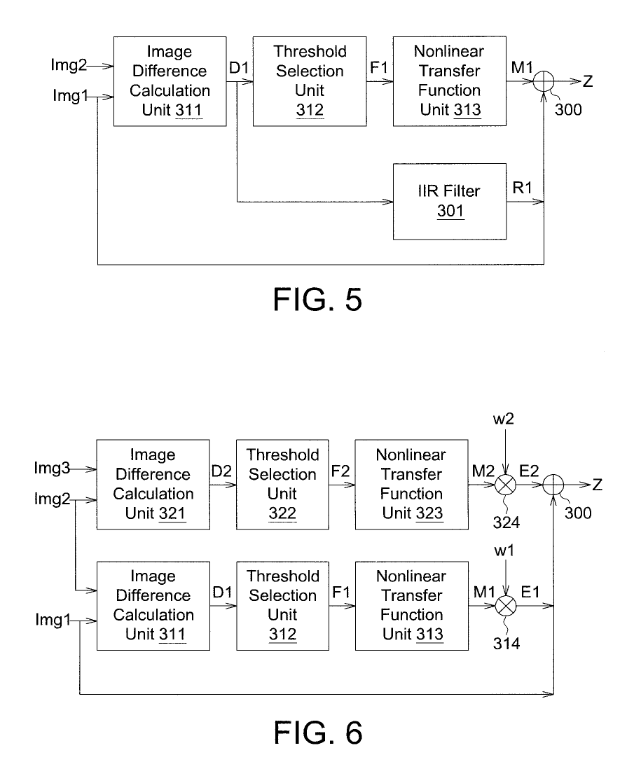

Other embodiments of the gas leakage detection method are given below. Taking the gas leakage detection system shown in FIG. 1 for example, different embodiments regarding the image processing device 102 are illustrated. FIG. 5 shows a diagram illustrating an image processing device according to an embodiment of this disclosure. In this example the image processing device 102 includes an image difference calculation unit 311, a threshold selection unit 312, a nonlinear transfer function unit 313, an infinite impulse response (IIR) filter 301, and an adder 300. These units may be implemented by hardware circuit or computer software (the same description will not be repeated for the following embodiments).

The image difference calculation unit 311 may perform the step S204 shown in FIG. 3 to generate the first difference image D1. The threshold selection unit 312 may perform the step S206 shown in FIG. 3 to generate the first filtered image F1. The nonlinear transfer function unit 313 may use the transfer function shown in FIG. 4A or FIG. 4B to perform the step S208 shown in FIG. 3 to generate the first detail image M1. The IIR filter 301 is optional and may perform filtering on the first difference image D1 to generate an output response image R1. The IIR filter 301 may include registers and feedback circuit (which may also be implemented by software). The output response of the IIR filter 301 for the current time first difference image D1 not only affects the gas leakage enhanced image Z for the current image frame but also affects the gas leakage enhanced image Z for the next image frame, the second next image frame, the third next image frame, and so on. The adder 300 may superimpose the output response image R1, the first detail image M1, and the first image Img1 to generate the gas leakage enhanced image Z. The IIR filter 301 is introduced in this embodiment to extend the impact duration of the first difference image D1. In this embodiment, the difference in one image frame does not disappear immediately, but rather diminishes gradually with time. The gas leakage enhanced image Z with better image quality can be obtained in this way.

FIG. 6 shows a diagram illustrating an image processing device according to an embodiment of this disclosure. In this example the image processing device 102 includes image difference calculation units 311 and 321, threshold selection units 312 and 322, nonlinear transfer function units 313 and 323, multipliers 314 and 324, and an adder 300. In this embodiment, the step S202 shown in FIG. 3 may further capture a third image Img3 from the infrared video X (or from the stabilized infrared video Y). The third image Img3, the second image Img2, and the first image Img1 are consecutive image frames in order. The image difference unit 321 may calculate the difference between the second image Img2 and the third image Img3 to generate a second difference image D2. The threshold selection unit 322 filters the second difference image D2 with the filtering criterion to generate the second filtered image F2. The nonlinear transfer function unit 323 transforms the second filtered image F2 with the transfer function to generate a second detail image M2. The top row (including blocks 321, 322, 323) and the bottom row (including blocks 311, 312, 313) in FIG. 6 operate similarly, and thus the detailed operation is not repeated herein.

The multiplier 314 is configured to multiply the first detail image M1 by a first time weight w1 to generate a first weighed image E1. The multiplier 324 is configured to multiply the second detail image M2 by a second time weight w2 to generate a second weighed image E2. The adder 300 superimposes the first weighted image E1, the second weighted image E2, and the first image Img1. In one embodiment, the first time weight w1 may be equal to the second time weight w2. For example, w1=w2=1, or w1=w2=0.5. In other words, the difference image has the same impact on the gas leakage enhanced image Z no matter being how far away from the current time instant. If the same time weight is used, the adder 300 may also be configured to directly superimpose the first detail image M1, the second detail image M2, and the first image Img1. In another embodiment, the first time weight w1 is greater than the second time weight w2. That is, a larger weight is assigned to a difference image closer to the current moment, such that the difference image that is closer to the current moment has a greater impact on the gas leakage enhanced image Z. The gas leakage enhanced image Z with better image quality can be obtained in this way.

As the embodiment shown in FIG. 6, three consecutive image frames are considered to obtain more image difference information. This embodiment may further be extended to accommodate more consecutive image frames in order, such as n consecutive image frames (n is a positive integer greater than 1). In this case, the architecture shown in FIG. 6 may include (n−1) rows, with each row including an image difference calculation unit, a threshold selection unit, a nonlinear transfer function unit, and a multiplier. The adder then superimposes the result generated by each row. In addition, the embodiment shown in FIG. 5 and FIG. 6 may also be combined. For example, n consecutive image frames may be used, and the IIR filter may be used in combination to perform filtering on the first difference image.

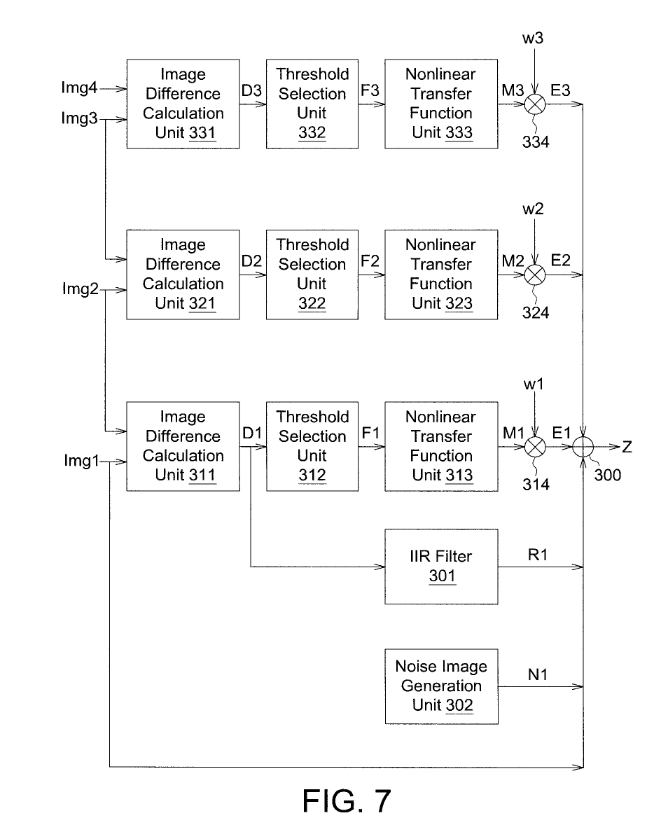

FIG. 7 shows a diagram illustrating an image processing device according to an embodiment of this disclosure. Four consecutive image frames are used in this embodiment. The step S202 shown in FIG. 3 may further capture a fourth image Img4 from the infrared video X (or from the stabilized infrared video Y). The fourth image Img4, the third image Img3, the second image Img2, and the first image Img1 are consecutive image frames in order. The image difference unit 331 may calculate the difference between the third image Img3 and the fourth image Img4 to generate a third difference image D3. The threshold selection unit 332 filters the third difference image D3 with the filtering criterion to generate the third filtered image F3. The nonlinear transfer function unit 333 transforms the third filtered image F2 with the transfer function to generate a third detail image M3. The multiplier 334 multiplies the third detail image M3 by a third time weight w3 to generate a third weighed image E3. In this embodiment, a noise image generation unit 302 may be optionally added, for generating a noise image N1 (such as Gaussian noise) independent of other image signals. The adder 300 superimposes the first weighed image E1, the second weighted image E2, the third weighted image E3, the output response image R1, the noise image N1, and the first image Img1 to generate the gas leakage enhanced image Z.

In some scenarios, the gas leakage enhanced image Z has better image quality with the addition of the noise image N1. For example, the visual block effect can be reduced. The embodiment shown in FIG. 7 may include more rows to accommodate more consecutive image frames arranged in time. The time weight may be set as follows: a larger weight is assigned to an image that is closer to the current moment. For example, the first time weight w1 is greater than the second time weight w2, the second time weight w2 is greater than the third time weight w3, and so on. The same rule for weight assignment may be applied if more time frames are used. As shown in FIG. 5-FIG. 7, two or more (corresponding to different number of rows in the figure) consecutive image frames in order may be used. The IIR filter, the time weight, and the noise image may be optionally used.

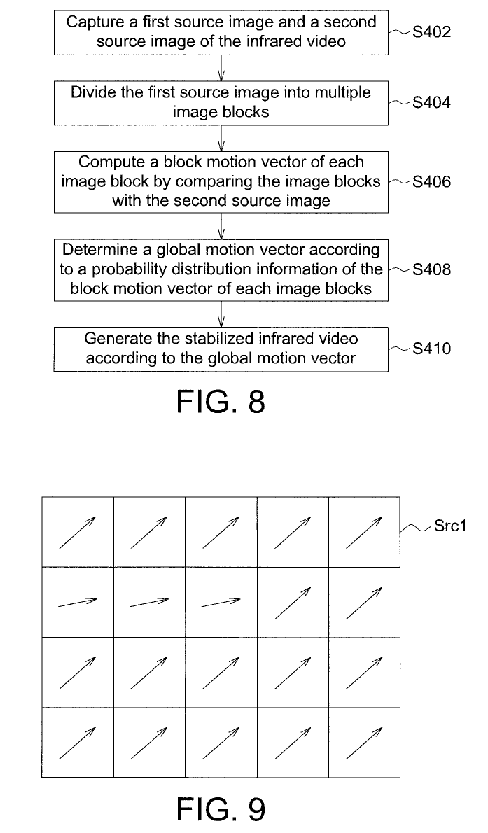

The step S130 image stabilization compensation shown in FIG. 2 may be referred to FIG. 8, which shows a flowchart for the image stabilization compensation step according to an embodiment of this disclosure. The image stabilization compensation includes the following steps. Step S402: Capture a first source image Src1 and a second source image Src2 of the infrared video X, wherein the second source image Src2 and the first source image Src1 are consecutive image frames in order. Step S404: Divide the first source image Src1 into multiple image blocks. For example, divide the first source image Src1 to equal-size image blocks. The size of the image blocks (the number of pixels inside the image block) may be 8×8, 16×16, 32×32, or other sizes.

Step S406: Compute a block motion vector of each image block by comparing the image blocks with the second source image Src2. For example, the step S406 may be implemented by the motion estimation technique. Motion estimation may be performed on each image block to obtain the block motion vector of each image block. FIG. 9 shows a diagram illustrating block motion vectors according to an embodiment of this disclosure. The arrow depicted in each image block of the first source image Src1 represents the block motion vector of each image block.

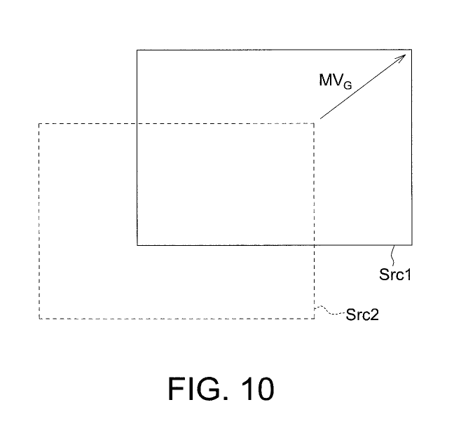

Step S408: Determine a global motion vector according to a probability distribution information of the block motion vector of each image blocks. As shown in FIG. 9, the number of each type of block motion vector may be calculated. In this example, the block motion vector that points toward top-right appears the most times. This block motion vector that points toward top-right may be taken as the global motion vector according to the probability distribution after statistical calculation. FIG. 10 shows a diagram illustrating the global motion vector according to an embodiment of this disclosure. The global motion vector MV_{G} that the first source image Src1 is relative to the second source image Src2 is determined according to the probability distribution information of the block motion vectors. Step S410: Generate the stabilized infrared video Y according to the global motion vector MV_{G}. The global motion vector MV_{G} may represent the amount that the handheld camera moves. Therefore the video may be compensated to produce a stabilized video with less image shaking according to the global motion vector MV_{G}.

In one embodiment, the step S406 of computing the block motion vector of each image block includes: selecting multiple characteristic points in each image block. The characteristic points may be points at a fixed distance within the image block. Alternatively, the characteristic points may be chosen according to a contour (an outline) of a human or an object. For example, edge detection technique may be used to find particular locations where pixel values change significantly to identify the characteristic points. Based on the multiple characteristic points, each block motion vector may be computed by comparing the multiple characteristic points with the second source image Src2. Because the characteristic points are near the object contour, motion estimation based on characteristic points can yield a more accurate estimation result, so that locations where gas leakage happens can be found more accurately.

In one embodiment, the step S408 of determining the global motion vector includes: calculating an image contrast of each image block, and assigning a block weight to each image block according to the image contrast. The image contrast may represent the luminance distribution of each pixel inside the image. For example, the larger the difference between the brightest point and the darkest point in an image block is, the larger the image contrast is. Next, the probability distribution information of the block motion vector of each image block may be obtained according to the block weight of each image block. For example, an image block having a larger block weight may be treated as the block motion vector of this image block appearing more times during statistical calculation. As such, the probability distribution information thus obtained is based on the block weight, and the global motion vector MV_{G} may be determined accordingly. In one embodiment, the image block with larger image contrast contributes more in computing the global motion vector MV_{G}. This is due to the fact that motion vector is likely to be misjudged in an image block with lower image contrast (such as an image block that is nearly pure white). Therefore, larger block weight may be assigned to the image block with higher image contrast, such that the global motion vector MV_{G} is more correlated to the block motion vectors that belong to image blocks with high image contrast.

In one embodiment, the step S410 of generating the stabilized infrared video Y includes: performing a smoothing operation on the global motion vector MV_{G} obtained at different time instants to calculate a compensation vector for the different time instants. The objective of the smoothing operation is to reduce the fluctuation range of the global motion vector MV_{G} changing with time. If the fluctuation range of the global motion vector MV_{G} is too large, the video will shake too severely. The smoothing operation prevents such situation during the stabilization compensation step. For example, the smoothing operation may perform low pass filtering on the global motion vectors MV_{G} obtained at different time instants. Then the infrared video X is shifted according to the compensation vector to generate the stabilized infrared video Y.

According to the embodiments described above, an image stabilization compensation step may optionally first be performed on the infrared thermal image. In this stabilization step, block motion vector and image contrast may be used to achieve more accurate motion vectors. Objects that are fixed in the image can be first identified by the image stabilization compensation step. Next, a gas leakage enhancement step may be performed. In this enhancement step, actual changes in the image may be identified based on the stabilized image, and then filtering and transfer function may be applied to magnify the difference. In addition, several successive image frames in time order and an IIR filter may be used to achieve a more accurate image enhancement result. As such, the user can quickly and accurately find where the gas leakage happens in the gas leakage enhanced image.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A gas leakage detection method, comprising:
receiving an infrared video;
capturing a first image and a second image from the infrared video, wherein the first image and the second image are consecutive image frames in order;
calculating a difference between the first image and the second image to generate a first difference image;
filtering the first difference image with a filtering criterion to generate a first filtered image;
transforming the first filtered image with a transfer function to generate a first detail image, wherein an absolute value of each pixel value in the first detail image is greater than or equal to an absolute value of each corresponding pixel value in the first filtered image; and
superimposing the first detail image and the first image to generate a gas leakage enhanced image.

2. The gas leakage detection method according to claim 1, wherein the step of filtering the first difference image with the filtering criterion comprises:
filtering out a pixel value in the first difference image having an absolute value greater than a difference upper bound or lower than a difference lower bound.

3. The gas leakage detection method according to claim 1, wherein the transfer function is a nonlinear transfer function.

4. The gas leakage detection method according to claim 1, wherein the transfer function is generated according to a sigmoid function.

5. The gas leakage detection method according to claim 1, further comprising filtering the first difference image with an infinite impulse response filter to generate an output response image;
wherein the step of generating the gas leakage enhanced image comprises:
superimposing the output response image, the first detail image, and the first image.

6. The gas leakage detection method according to claim 1, further comprising:
capturing a third image from the infrared video, wherein the first image, the second image, and the third image are consecutive image frames in order;
calculating a difference between the second image and the third image to generate a second difference image;
filtering the second difference image with the filtering criterion to generate a second filtered image; and
transforming the second filtered image with the transfer function to generate a second detail image;
wherein the step of generating the gas leakage enhanced image comprises:
superimposing the first detail image, the second detail image, and the first image.

7. The gas leakage detection method according to claim 6, wherein the step of generating the gas leakage enhanced image comprises:
multiplying the first detail image by a first time weight to generate a first weighted image;
multiplying the second detail image by a second time weight to generate a second weighted image; and
superimposing the first weighted image, the second weighted image, and the first image.

8. The gas leakage detection method according to claim 7, wherein the first time weight is greater than the second time weight.

9. The gas leakage detection method according to claim 8, further comprising:
capturing a fourth image from the infrared video, wherein the first image, the second image, the third image, and the fourth image are consecutive image frames in order;
calculating a difference between the third image and the fourth image to generate a third difference image;
filtering the third difference image with the filtering criterion to generate a third filtered image; and
transforming the third filtered image with the transfer function to generate a third detail image;
wherein the step of generating the gas leakage enhanced image comprises:
multiplying the third detail image by a third time weight to generate a third weighted image; and
superimposing the first weighted image, the second weighted image, the third weighted image, and the first image;
wherein the second time weight is greater than the third time weight.

10. The gas leakage detection method according to claim 1, wherein the step of generating the gas leakage enhanced image comprises:
superimposing a noise image, the first detail image, and the first image.

11. The gas leakage detection method according to claim 1, further comprising:
performing an image stabilization compensation step on the infrared video to generate a stabilized infrared video;
wherein the first image and the second image are captured from the stabilized infrared video.

12. The gas leakage detection method according to claim 11, wherein the image stabilization compensation step comprises:
capturing a first source image and a second source image of the infrared video, wherein the second source image and the first source image are consecutive image frames in order;
dividing the first source image into a plurality of image blocks;
computing a block motion vector of each of the plurality of image blocks by comparing the plurality of image blocks with the second source image;
determining a global motion vector according to a probability distribution information of the block motion vector of each of the plurality of image blocks; and
generating the stabilized infrared video according to the global motion vector.

13. The gas leakage detection method according to claim 12, wherein the step of computing the block motion vector of each of the plurality of image blocks comprises:
selecting a plurality of characteristic points in each of the plurality of image blocks;
computing the block motion vector of each of the plurality of image blocks by comparing the plurality of characteristic points with the second source image.

14. The gas leakage detection method according to claim 12, wherein the step of determining the global motion vector comprises:
calculating an image contrast of each of the plurality of image blocks;
assigning a block weight to each of the plurality of image blocks according to the image contrast; and
obtaining the probability distribution information of the block motion vector of each of the plurality of image blocks according to the block weight of each of the plurality of image blocks.

15. The gas leakage detection method according to claim 14, wherein the higher the image contrast is, the larger the block weight is.

16. The gas leakage detection method according to claim 12, wherein the step of generating the stabilized infrared video comprises:
performing a smoothing operation on the global motion vector obtained at different time instants to calculate a compensation vector for the different time instants;
shifting the infrared video according to the compensation vector to generate the stabilized infrared video.
